(19) United States
(12) Patent Application Publication
(10) Pub. No.: US 2022/0231343 A1
(43) Pub. Date: Jul. 21, 2022

(54) SOLID-STATE BATTERY AND SOLID-STATE BATTERY UNIT

(71) Applicant: HONDA MOTOR CO., LTD., Tokyo (JP)

(72) Inventors: Toshiyuki ARIGA, Saitama (JP); Takuya TANIUCHI, Saitama (JP); Masahiro OHTA, Saitama (JP)

(21) Appl. No.: 17/456,883

(22) Filed: Nov. 29, 2021

(30) Foreign Application Priority Data
Jan. 18, 2021 (JP) 2021-005949

(51) Int. Cl. H01M 10/0585; H01M 10/0525; H01M 50/121; H01M 50/533; H01M 50/593

(52) U.S. Cl. CPC H01M 10/0585; H01M 10/0525; H01M 50/593; H01M 50/533; H01M 50/121

(57) ABSTRACT

A solid-state battery includes: a solid-state battery cell Including a laminate having at least one positive electrode having a positive electrode current collector and a positive electrode active material layer, at least one negative electrode having a negative electrode current collector and a negative electrode active material layer, and a solid-state electrolyte interposed between the positive electrode and the negative electrode, and a first elastic member arranged at least on both sides of the laminate in a laminating direction; and a resin casing made of a thermosetting resin or a thermoplastic resin and which closely adheres to and covers the solid-state battery cell.

This application is based on and claims the benefit of priority from Japanese Patent Application No. 2021-005949, filed on 18 Jan. 2021, the content of which is incorporated herein by reference.

### BACKGROUND OF THE INVENTION

### Field of the Invention

The present invention relates to a solid-state battery and a solid-state battery unit.

### Related Art

In recent years, the proliferation of electrical and electronic devices of various sizes, such as automobiles, personal computers, and cell phones, has led to a drastically increasing demand for high-capacity, high-output batteries. One such battery is a solid-state battery including a laminate in which a flame-retardant solid-state electrolyte is interposed between the positive electrode and the negative electrode. Examples of such solid-state batteries include a solid-state battery in which the laminate is covered with resin.

For example, Patent Document 1 describes a solid-state battery in which a solid battery element is covered with a thermosetting resin or a thermoplastic resin. In addition, Patent Document 2 describes a solid-state battery in which at least a side surface of an all-solid-state battery laminate is covered, and a cavity is present between a side surface of at least a negative electrode active material layer and a resin casing.

Patent Document 1: Japanese Unexamined Patent Application, Publication No. 2000-106154

Patent Document 2: Japanese Unexamined Patent Application, Publication No. 2019-121532

### SUMMARY OF THE INVENTION

In a solid-state battery in which the laminate is covered with resin as in Patent Document 1, a change in volume of the negative electrode active material layer in the laminate occurs due to charging or discharging, and there is thus a risk of cracks occurring in the resin casing. To address this concern, the solid-state battery of Patent Document 2 has a cavity between the side surface of the negative electrode active material layer and the resin casing, which allows the negative electrode active material layer to expand in a direction orthogonal to the laminating direction if a change in volume of the negative electrode active material occurs, allowing for suppression of the occurrence of cracks in the resin casing.

However, in the solid-state battery of Patent Document 2, the presence of the cavity between the side surface of the negative electrode active material layer and the resin casing means that the side surface of the laminate in the direction orthogonal to the laminating direction, as well as any current collector tabs formed on said side surface, would not be sufficiently protected, and there is therefore room for improvement in terms of assuring greater mechanical strength.

The present invention has an object of providing a solid-state battery or a solid state battery unit including a laminate covered with a resin casing, which is capable of ensuring a higher mechanical strength while suppressing damage to the resin casing due to changes in volume of the laminate.

The present invention relates to a solid-state battery including: a solid-state battery cell including a laminate having at least one positive electrode having a positive electrode current collector and a positive electrode active material layer, at least one negative electrode having a negative electrode current collector and a negative electrode active material layer, and a solid-state electrolyte interposed between the positive electrode and the negative electrode, and a first elastic member arranged at least on both sides of the laminate in a laminating direction; and a resin casing that is made of a thermosetting resin or a thermoplastic resin and closely adheres to and covers the solid-state battery cell.

The solid-state battery cell may further include a positive electrode current collector tab extending in a direction away from the laminate from an end portion of the positive electrode current collector in a direction orthogonal to the laminating direction; and a negative electrode current collector tab extending in a direction away from the laminate from an end portion of the negative electrode current collector in a direction orthogonal to the laminating direction, the resin casing closely adhering to and covering the positive electrode current collector tab and the negative electrode current collector tab.

A surface of the first elastic member that is in contact with the laminate may have an area equal to or greater than that of a surface of the negative electrode active material layer orthogonal to the laminating direction.

A total maximum compression amount in a thickness direction of the first elastic member arranged on both sides of the laminate in the laminating direction may be greater than a maximum expansion amount of the laminate.

A negative electrode active material constituting the negative electrode active material layer may be hard carbon.

A negative electrode active material constituting the negative electrode active material layer may be graphite, and a capacity ratio (negative capacity/positive capacity) of the negative electrode and the positive electrode may be 1.1 or more.

The present invention also relates to a solid-state battery unit including: a solid-state battery module including a group of a plurality of laminates each having at least one positive electrode having a positive electrode current collector and a positive electrode active material layer, at least one negative electrode having a negative electrode current collector and a negative electrode active material layer, and a solid-state electrolyte interposed between the positive electrode and the negative electrode, the laminates being stacked in a laminating direction of each laminate, and a second elastic member arranged at least on both sides of the laminate group in the laminating direction; and a module resin casing made of a thermosetting resin or a thermoplastic resin and which closely adheres to and covers the solid-state battery module.

The second elastic member may be arranged on both sides in the laminating direction of each of the plurality of laminates.

According to the present invention, it is possible to provide a solid-state battery or a solid-state battery unit including a laminate covered with a resin casing, which is capable of ensuring a higher mechanical strength while suppressing damage to the resin casing due to changes in volume of the laminate.

### BRIEF DESCRIPTION OF THE DRAWINGS

FIG. 1 is a perspective view showing a solid-state battery according to an embodiment of the present invention;

FIG. 2 is a cross-sectional view taken along line A-A in FIG. 1;

FIG. 3 is a perspective view showing a solid-state battery unit according to an embodiment of the present invention; and

FIG. 4 is a cross-sectional view taken along line B-B in FIG. 3.

### DETAILED DESCRIPTION OF THE INVENTION

An embodiment of the present invention is described below with reference to the drawings. However, the embodiment shown below is merely an example of the present invention, and the invention is not limited to this embodiment.

### <Solid-State Battery>

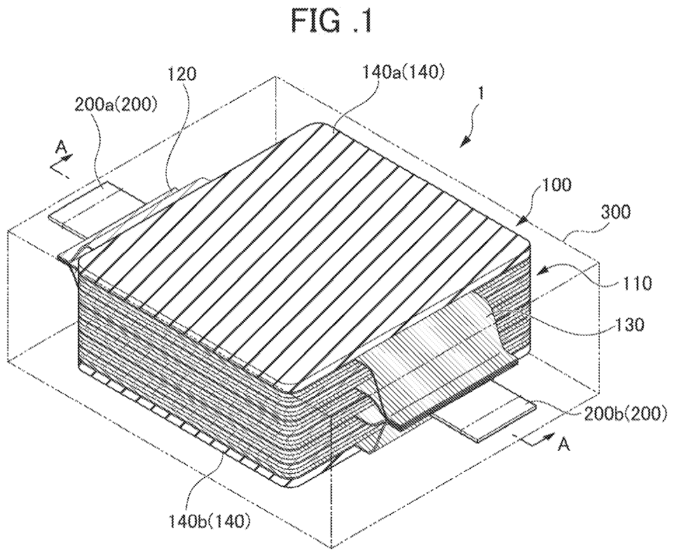

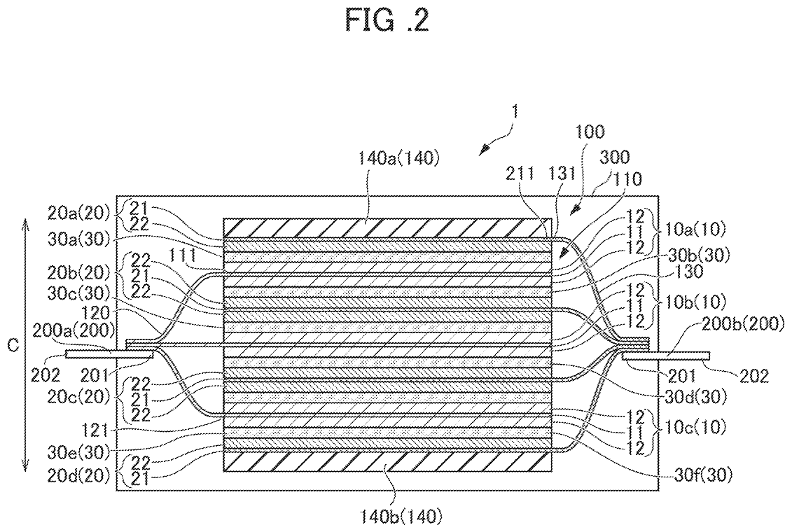

A solid-state battery 1 according to the present invention is described with reference to FIG. 1 and FIG. 2. FIG. 1 is a perspective view of the solid-state battery 1. FIG. 2 is a cross-sectional view taken along line A-A of the solid-state battery 1 in FIG. 1. It should be noted that, in FIG. 1, a resin casing 300 is shown by a long-dash double-short-dash line, and in FIG. 2, hatching of lead terminals 200 and the resin casing 300 is omitted to avoid complication of the illustration.

As shown in FIG. 1 and FIG. 2, the solid-state battery 1 according to the present embodiment, includes a solid-state battery cell 100, lead terminals 200, and a resin casing 300.

### (Solid-State Battery Cell)

The solid-state battery cell 100 includes a laminate 110, a positive electrode current collector tab 120, a negative electrode current collector tab 130, and first elastic members 140.

### [Laminate]

The laminate 110 has at least one positive electrode 10, at least one negative electrode 20, and a solid-state electrolyte 30 interposed between the positive electrode 10 and the negative electrode 20. In the present embodiment, as shown in FIG. 2, the laminate as a whole has an approximately rectangular cuboidal shape, where three positive electrodes 10 in the form of positive electrodes 10a, 10b, and 10c, four negative electrodes 20 in the form of negative electrodes 20a, 20b, 20c, and 20d, and six solid-state electrolytes 30 in the form of solid-state electrolytes 30a, 30b, 30c, 30d, 30e, and 30f, are laminated. Specifically, the above elements are laminated in the following order from one side (the upper side in FIG. 2) in a laminating direction C of the laminate 110: negative electrode 20a, solid-state electrolyte 30a, positive electrode 10a, solid-state electrolyte 30b, negative electrode 20b, solid-state electrolyte 30c, positive electrode 10b, solid-state electrolyte 30d, negative electrode 20c, solid-state electrolyte 30e, positive electrode 10c, solid-state electrolyte 30f, negative electrode 20d. The laminating direction C is indicated by a double-headed arrow in FIG. 2.

### [Positive Electrode]

Each of the three positive electrodes 10 has a plate-shaped positive electrode current collector 11 and plate-shaped positive electrode active material layers 12. As shown in FIG. 2, the positive electrode active material layers 12 are arranged on both surfaces of the positive electrode current collector 11 in the laminating direction C.

### [Positive Electrode Current Collector]

The positive electrode current collector 11 is not particularly limited, and any well-known current collector usable in positive electrodes of solid-state batteries may be applied. Examples include metallic foils such as a stainless steel (SUS) foil, an aluminum (Al) foil, etc.

A positive electrode current collector tab 120 is formed at an end portion 111 on one side (the left side in FIG. 2) of the positive electrode current collector 11 in a direction orthogonal to the laminating direction C. Specifically, the positive electrode current collector tabs 120 of the positive electrodes 10a to 10c extend in a direction away from the laminate 110 at the end portions 111 of the respective positive electrode current collectors 11.

The respective positive electrode current collector tabs 120 of the positive electrodes 10a to 10c are bonded to a lead terminal 200 described later, with their end portions opposite from the laminate 110 being bundled together. The bonding method is not particularly limited, and any well-known method, including welding methods such as vibration welding or ultrasonic welding, etc. may be used.

The positive electrode current collector tab 120 may be formed in one piece with the positive electrode current collector 11, or it may be a different member from the positive electrode current collector 11 and be electrically connected to the end portion 111 of the positive electrode current collector 11 by welding or the like. The positive electrode current collector tab 120 according to the present embodiment is formed in one piece with the positive electrode current collector 11. In the present embodiment, the positive electrode current collector 11 is a portion that is in contact with the positive electrode active material layer 12 of one metallic foil and is pressed out by pressure in the laminating direction C, and the positive electrode current collector tab 120 is a portion that is not in contact with the positive electrode active material layer 12 of the one metallic foil and is not pressed out. This means that a weak fragile portion 121 is formed at the boundary between the pressed positive electrode current collector 11 and the unpressed positive electrode current collector tab 120.

The width of the positive electrode current collector tab 120 is appropriately set to minimize resistance according to the intended use, with the width of the bonding material being the maximum width, and is preferably 1 mm to 1000 mm, and more preferably 2 mm to 300 mm. The thickness is generally about 5 to 50 μm, and the length is generally 5 to 50 mm.

### [Positive Electrode Active Material Layer]

The material constituting the positive electrode active material layer 12 is not particularly limited, and any material known to be usable as a positive electrode active material in a solid-state battery may be applied. The composition thereof is also not particularly limited, and may include, other than the positive electrode active material, a solid-state electrolyte, an electroconductive agent, etc.

Positive electrode active materials include, for example, transition metal chalcogenides such as titanium disulfide, molybdenum disulfide, and niobium selenide, and transition metal oxides such as lithium nickel oxide (LiNiO₂), lithium manganese oxide (LiMnO₂, LiMn₂O₄), and lithium cobalt oxide. (LiCoO₂).

### [Negative Electrode]

Each of the four negative electrodes 20 has a plate-shaped negative electrode current collector 21 and a plate-shaped negative electrode active material layer 22. As shown in FIG. 2, the negative electrode active material layers 22 are arranged on one or both surfaces of the negative electrode current collector 21 in the laminating direction C.

### [Negative Electrode Current Collector]

The negative electrode current collector 21 is not particularly limited, and any well-known current collector usable in negative electrodes of solid-state batteries may be applied. Examples include metallic foils such as a stainless steel (SUS) foil, a copper (Cu) foil, etc.

A negative electrode current collector tab 130 is formed at an end portion 211 on the other side (the right side in FIG. 2) of the negative electrode current collector 21 in a direction orthogonal to the laminating direction C. Specifically, the negative electrode current collector tabs 130 of the negative electrodes 20a to 20d extend in a direction away from the laminate 110 at the end portions 211 of the respective negative electrode current collectors 21.

The respective negative electrode current collector tabs 130 of the negative electrodes 20a to 20d are bonded to a lead terminal 200 described later, with their end portions opposite from the laminate 110 being bundled together. The bonding method is not particularly limited, and any well-known method, including welding methods such as vibration welding or ultrasonic welding, etc. may be used.

The negative electrode current collector tab 130 may be formed in one piece with the negative electrode current collector 21, or it may be a different member from the negative electrode current collector 21 and be electrically connected to the end portion 211 of the negative electrode current collector 21 by welding or the like. The negative electrode current collector tab 130 according to the present embodiment is formed in one piece with the negative electrode current collector 21. In the present embodiment, the negative electrode current collector 21 is a portion that is in contact with the negative electrode active material layer 22 of one metallic foil and is pressed out by pressure in the laminating direction C, and the negative electrode current collector tab 130 is a portion that is not in contact with the negative electrode active material layer 22 of the one metallic foil and is not pressed out. This means that a weak fragile portion 131 is formed at the boundary between the pressed negative electrode current collector 21 and the unpressed negative electrode current collector tab 130.

The width of the negative electrode current collector tab 130 is appropriately set to minimize resistance according to the intended use, with the width of the bonding material being the maximum width, and is preferably 1 mm to 1000 mm, and more preferably 2 mm to 300 mm. The thickness is generally about 5 to 50 μm, and the length is generally 5 to 50 mm.

### [Negative Electrode Active Material Layer]

The material constituting the negative electrode active material layer 22 is not particularly limited, and any material known to be usable as a negative electrode active material in a solid-state battery may be applied. The composition thereof is also not particularly limited, and may include, other than the negative electrode active material, a solid-state electrolyte, an electroconductive agent, etc.

The negative electrode active material is not particularly limited, so long as it can absorb and release lithium ions. Negative electrode active materials include, for example, metallic lithium, a lithium alloy, a metal oxide, a metal nitride, Si, SiO, and carbon materials such as graphite, hard carbon, soft carbon, etc. Considering the small volume change of the negative electrode 20, hard carbon, which exhibits a small volume change due to electric charge and discharge is preferably used as the negative electrode active material. In addition, similar to hard carbon, considering the small volume change of the negative electrode 20, it is preferable to use graphite as the negative electrode active material and to make the capacity ratio (negative capacity/positive capacity) of the negative electrodes 20 and the positive electrodes 10 be 1.1 or more.

### [Solid-State Electrolyte]

The solid state electrolyte 30 is laminated between the positive electrodes 10 and the negative electrodes 20, and is formed, for example, as layers. The solid-state electrolyte 30 is a layer that contains at least a solid-state electrolyte material. Charge transfer between the positive electrode active material and the negative electrode active material can be performed through the above solid-state electrolyte material.

The solid-state electrolyte material is not particularly limited, and may be, for example, a sulfide solid-state electrolyte material, an oxide solid-state electrolyte material, a nitride solid-state electrolyte material, a halide solid-state electrolyte material, etc.

### [First Elastic Member]

The first elastic member 140 is a plate-shaped, highly elastic member. The first, elastic member 140 may be natural rubber, diene rubber, non-diene rubber, etc. In the present embodiment, a styrene-butadiene rubber plate is used as the first elastic member 140.

The first elastic members 140 are arranged at least on both sides of the laminate 110 in the laminating direction C. In the present embodiment, as shown in FIG. 1 and FIG. 2, two first elastic members 140 in the form of a first elastic member 140a and a first elastic member 140b are arranged on both sides of the laminate 110 in the laminating direction C.

The first elastic member 140a is arranged on one side (the upper side in FIG. 2) of the laminate 110 in the laminating direction C, and the first elastic member 140b is arranged on the other side (the lower side in FIG. 2) of the laminate 110 in the laminating direction C. Specifically, the first elastic member 140a is arranged to be in contact with the entire surface of the negative electrode current collector 21 of the negative electrode 20a on one side in the laminating direction C (the upper side in FIG. 2), and the first elastic member 140b is arranged to be in contact with the entire surface of the negative electrode current collector 21 of the negative electrode 20d on the other side (the lower side in FIG. 2) in the laminating direction C. According to this configuration, even if, for example, charging of the solid-state battery 1 causes the negative electrode active material layers 22 to expand, increasing the volume of the laminate 110, the first elastic members 140 can be compressed in the laminating direction C in response to the increase in volume. That is to say, even if the volume of the laminate 110 increases, compression of the first elastic members 140 can maintain a constant overall volume of the solid-state battery cell 100.

The area of the surface of the first elastic member 140a in contact with the laminate 110 is equal to or greater than the areas of the surfaces of the negative electrode active material layers 22 of the electrodes 20 orthogonal to the laminating direction C. Likewise, the area of the surface of the first elastic member 140b in contact, with the laminate 110 is equal to or greater than the areas of the surfaces of the negative electrode active material layers 22 of the electrodes 20 orthogonal to the laminating direction C.

In addition, the solid-state battery cell 100 is configured so that a total maximum compression amount in the thickness direction of the first elastic members 140 arranged on both sides of the laminate 110 in the laminating direction C is greater than a maximum expansion amount of the laminate 110. Specifically, it is configured so that the total maximum compression amount in the thickness direction of the first elastic members 140a, 140b is greater than the total expansion amount of all the negative electrode active material layers 22 included in the laminate 110. It should be noted that the dimensions, such as thickness, length, and width, as well as the materials of the first elastic members 140a, 140b may be the same or different.

### (Lead Terminal)

As shown in FIG. 2, an end portion 201 on one side (the laminate 110 side in FIG. 2) of the lead terminal 200 is electrically connected to the plurality of positive electrode current collector tabs 120 or negative electrode current collector tabs 130 by welding or the like, and an end portion 202 on the other side (the opposite side from the laminate 110 in FIG. 2) extends from the resin casing 300 to the outside, constituting an electrode portion of the solid-state battery cell 100. The material of the lead terminal 200 may be the same material as that of a current collector tab lead used in a conventional solid-state battery, and is not particularly limited.

As shown in FIG. 2, in the present embodiment, two lead terminals 200 in the form of lead terminals 200a and 200b are connected to the solid-state battery cell 100. Specifically, the lead terminal 200a is connected to the plurality of positive electrode current collector tabs 120, and the lead terminal 200b is connected to the plurality of negative electrode current collector tabs 130.

### (Resin Casing)

The resin casing 300 is made from a thermosetting resin or a thermoplastic resin. The resin used in the resin casing 300 preferably has a melting point that is less than 200° C., which is the temperature at which the positive electrode active material, negative electrode active material, and solid-state catalyst of the solid-state battery 1 are affected. Types of resin include, for example, polyvinyl chloride (PVC), polyvinylidene chloride (PVDC), polystyrene (PS), acrylonitrile-styrene resin (AS), acrylonitrile-butadiene-styrene resin (ABS), polyethylene (PE), ethylene vinyl acetate (EVA), polypropylene (PP), polyacetal (POM), acrylic resin (PMMA), methyl methacrylate-styrene copolymer (MS), polycarbonate (PC), polyurethane (PU), polyvinylidene fluoride (PVDF), etc.

The resin casing 300 closely adheres to and covers the entire solid-state battery cell 100. In other words, the resin casing 300 closely adheres to and covers the four side surfaces of the laminate 110 orthogonal to the laminating direction C, the four side surfaces orthogonal to the laminating direction C and the surface opposite the surface in contact with the laminate 110 in the laminating direction C of each first elastic member 140, the positive electrode current collector tabs 120, and the negative electrode current collector tabs 130. In addition, the resin casing 300 closely adheres to and covers the respective end portions 201 of the lead terminal 200a connected to the plurality of positive electrode current; collector tabs 120 and the lead terminal 200b connected to the plurality of negative electrode current collector tabs 130.

The method for forming the resin casing 300 is not particularly limited, and any known method may be used. For example, the resin casing 300 may be formed by placing the solid-state battery cell 100 with the lead terminals 200a and 200b connected thereto in a die, filling the die with a thermosetting resin or a thermoplastic resin in liquid form at or below the melting point, and then curing the resin. At this time, the respective end portions 202 of the lead terminals 200a and 200b are arranged outside of the die, and the respective end portions 201 of the lead terminals 200a and 200b are positioned inside the die.

The solid-state battery 1 according to the present embodiment, exhibits the following effects. The solid-state battery 1 according to the present embodiment includes: a solid-state battery cell 100 including a laminate 110, the laminate 110 having at least one positive electrode 10 having a positive electrode current collector 11 and a positive electrode active material layer 12, at least one negative electrode 20 having a negative electrode current collector 21 and a negative electrode active material layer 22, and a solid state catalyst 30 interposed between the positive electrode 10 and the negative electrode 20, and first elastic members 140 arranged at least on both sides of the laminate 110 In the laminating direction C; and a resin casing 300 made of a thermosetting resin or a thermoplastic resin and which closely adheres to and covers the solid-state battery cell 100. The resin casing 300 thus closely adheres to and covers the entire solid-state battery cell 100 including the laminate 110, allowing for more reliable protection of the entire solid-state battery cell 100. Further, even if the entire solid-state battery cell 100 is covered by the resin casing 300 without any gaps, if a change in volume of the laminate 110 occurs due to expansion of the negative electrode active material layers 22 caused by charging or discharging, the first elastic members 140 interposed between the laminate 110 and the resin casing 300 will be compressed according to the change in volume. In other words, even if the volume of the laminate 110 in the laminating direction C changes, the compression of the first elastic members 140 allows for suppression of the occurrence of cracks in the resin casing 300. It is thus possible to ensure a higher mechanical strength of the solid-state battery 1 while suppressing damage to the resin casing 300 due to changes in volume of the laminate 110.

In addition, the solid-state battery cell 100 of the solid-state battery 1 according to the present embodiment further includes positive electrode current collector tabs 120 extending, in a direction away from the laminate 110, from the end portions 111 of the positive electrode current collectors 11 in a direction orthogonal to the laminating direction C, and negative electrode current collector tabs 130 extending, in a direction away from the laminate 110, from the end portions 211 of the negative electrode current collectors 21 in a direction orthogonal to the laminating direction C, and the resin casing 300 closely adheres to and covers the positive electrode current collector tabs 120 and the negative electrode current collector tabs 130. The entirety of the positive electrode current collector tabs 120 including the weak fragile portions 121, and the entirety of the negative electrode current collector tabs 130 including the weak fragile portions 131, are thus protected by the resin casing 300. It is thus possible to improve the mechanical strength of the positive electrode current collector tabs 120 and the negative electrode current collector tabs 130 while suppressing the occurrence of cracks in the resin casing 300 by means of the first elastic members 140 that can compress and expand according to changes in volume of the laminate 110.

In addition, in the solid-state battery cell 100 of the solid-state battery 1 according to the present embodiment, the area of the surface of each first elastic member 140 in contact with the laminate 110 is equal to or greater than the areas of the surfaces of the negative electrode active material layers 22 orthogonal to the laminating direction C. This allows for expansion and compression of the first elastic members 140 according to a change in volume of the entire surface of the negative electrode active material layers 22 orthogonal to the laminating direction C. It is thus possible to more reliably suppress damage to the resin casing 300 due to changes in volume of the laminate 110.

In addition, in the solid-state battery 1 according to the present embodiment, the total maximum compression amount in the thickness direction of the first elastic members 140 arranged on both sides of the laminate 110 in the laminating direction C is greater than the maximum expansion amount of the laminate 110. Therefore, even if all of the negative electrode active material layers 22 in the laminate 110 were to expand by the maximum expansion amount in the laminating direction C, the first elastic members 140 arranged by the laminate 110 will be compressed according to the expansion, which makes it possible to more reliably suppress damage to the resin casing 300 due to changes in volume of the laminate 110.

In addition, in the solid-state battery 1 according to the present invention, the negative electrode active material constituting the negative electrode active material layers 22 is hard carbon. This allows for a reduction of the volume change amount of the laminate 110 due to expansion or contraction of the negative electrode active material layers 22 caused by charging or discharging.

In addition, in the solid-state battery 1 according to the present embodiment, the negative electrode active material constituting the negative electrode active material layers 22 is a graphite active material, and the capacity ratio (negative capacity/positive capacity) of the negative electrodes 20 and the positive electrodes 10 is 1.1 or more. This allows for a reduction of the volume change amount of the laminate 110 due to expansion or contraction of the negative electrode active material layers 22 caused by charging or discharging.

### <Solid-State Battery Unit>

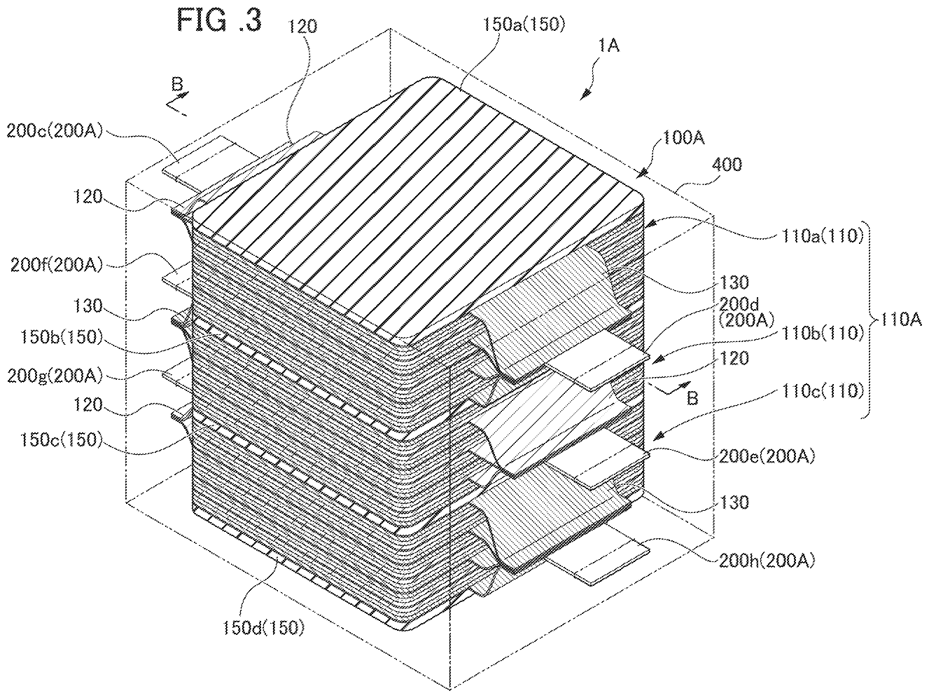

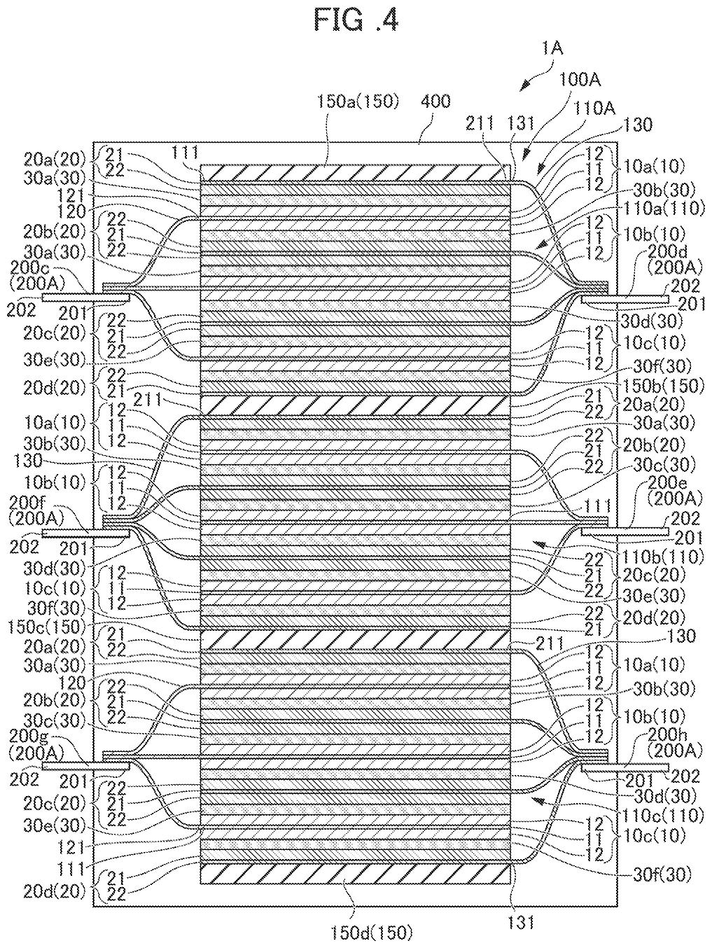

Next, a solid-state battery unit 1A according to the present embodiment is described with reference to FIG. 3 and FIG. 4. FIG. 3 is a perspective view of the solid-state battery unit 1A. FIG. 4 is a cross-sectional view taken along line B-B of the solid-state battery unit 1A in FIG. 3. It should be noted that, in FIG. 3, a module resin casing 400 is shown by a long-dash double-short-dash line, and in FIG. 4, hatching of lead terminals 200A and the module resin casing 400 is omitted to avoid complication of the illustration. Moreover, the same constituents as the ones of the solid-state battery 1 are given the same reference numerals, and description thereof is omitted.

As shown in FIG. 3 and FIG. 4, the solid-state battery unit 1A includes a solid-state battery module 100A, lead terminals 200A, and a module resin casing 400.

### (Solid-State Battery Module)

The solid-state battery module 100A includes a laminate group 110A, a positive electrode current collector tab 120, a negative electrode current collector tab 130, and second elastic members 150.

### [Laminate Group]

The laminate group 110A is composed of a plurality of laminates 110 laminated in laminating direction C. In the present embodiment, as shown in FIG. 3 and FIG. 4, the laminate group 110A has an approximately rectangular cuboidal shape, where three laminates 110 in the form of laminates 11 110b, and 110c are laminated in that order.

### [Second Elastic Member]

The second elastic member 150 is a plate-shaped, highly elastic member. The second elastic member 150 may be natural rubber, diene rubber, non-diene rubber, etc. In the present embodiment, a styrene-butadiene rubber plate is used as the second elastic member 150.

The second elastic members 150 are arranged at least on both sides of the laminate group 110A in the laminating direction C. In the present embodiment, as shown in FIG. 3 and FIG. 4, four second elastic members 150 in the form of second elastic members 150a, 150b, 150c, and 150d are arranged in the laminate group 110A.

The second elastic member 150a is arranged on one side (the upper side in FIG. 4) of the laminate group 110A in the laminating direction C. Specifically, the second elastic member 150a is arranged to be in contact with the entire surface of the negative electrode current collector 21 of the negative electrode 20a of the laminate 110a on one side in the laminating direction C (the upper side in FIG. A).

The second elastic member 150d is arranged on the other side (the lower side in FIG. 4) of the laminate group 110A in the laminating direction C. Specifically, the second elastic member 150b is arranged to be in contact with the entire surface of the negative electrode current collector 21 of the negative electrode 20d on the other side (the lower side in FIG. 4) of the laminate 110c in the laminating direction C.

The second elastic member 150b is arranged between the laminate 110a and the laminate 110b. Specifically, the second elastic member 150b is arranged to be in contact with the entire surface of the negative electrode current collector 21 of the negative electrode 20d on the other side (the lower side in FIG. 4) of the laminate 110a in the laminating direction C, and to be in contact with the entire surface of the negative electrode current collector 21 of the negative electrode 20a on one side (the upper side in FIG. 4) of the laminate 110b in the laminating direction C.

The second elastic member 150c is arranged between the laminate 110b and the laminate 110c. Specifically, the second elastic member 150c is arranged to be in contact, with the entire surface of the negative electrode current collector 21 of the negative electrode 20d on the other side (the lower side in FIG. 4) of the laminate 110b in the laminating direction C, and to be in contact with the entire surface of the negative electrode current collector 21 of the negative electrode 20a on one side (the upper side in FIG. 4) of the laminate 110c in the laminating direction C.

The areas of the surfaces of the second elastic members 150a to 150d in contact with the respective laminates 110 are equal to or greater than the areas of the surfaces of the negative electrode active material layers 22 in the laminates 110 orthogonal to the laminating direction C. This allows for expansion and compression of the second elastic members 150 according to a change in volume of the entire surface of the negative electrode active material layers 22 orthogonal to the laminating direction C.

In addition, the solid-state battery module 100A is configured so that a total maximum compression amount in the thickness direction of all the second elastic members 150 arranged in the laminate group 110A is greater than a maximum expansion amount of the laminate group 110A. Specifically, it is configured so that the total maximum compression amount in the thickness direction of the second elastic members 150a to 150d is greater than the total expansion amount of all the negative electrode active material layers 22 included in the laminate group 110A. Therefore, even if all of the negative electrode active material layers 22 in the laminate group 110A were to expand by the maximum expansion amount in the laminating direction C, the second elastic members 150 arranged in the laminate group 110A can be compressed according to the expansion. It should be noted that the dimensions, such as thickness, length, and width, as well as the materials of the second elastic members 150a to 150d may be the same or different.

### (Lead Terminal)

As shown in FIG. 4, an end portion 201 on one side (the laminate group 110A side in FIG. 4) of the lead terminal 200A is electrically connected to the plurality of positive electrode current collector tabs 120 or negative electrode current collector tabs 130 by welding or the like, and an end portion 202 on the other side (the opposite side from the laminate group 110A in FIG. 4) extends from the module resin casing 400 to the outside, constituting an electrode portion of the solid-state battery unit 1A. The material of the lead terminal 200A, like that of the lead terminal 200, may be the same material as that of a current collector tab lead used in a conventional solid-state battery, and is not particularly limited.

As shown in FIG. 4, six lead terminals 200A in the form of lead terminals 200c, 200d, 200e, 200f, 200g, and 200h are electrically connected to the solid-state battery module 100A. Specifically, the lead terminal 200c is connected to the plurality of positive electrode current collector tabs 120 extending from the laminate 110a, the lead terminal 200d is connected to the plurality of negative electrode current collector tabs 130 extending from the laminate 110a, the lead terminal 200e is connected to the plurality of positive electrode current collector tabs 120 extending from the laminate 110b, the lead terminal 200f is connected to the plurality of negative electrode current collector tabs 130 extending from the laminate 110b, the lead terminal 200g is connected to the plurality of positive electrode current collector tabs 120 extending from the laminate 110c, and the lead terminal 200h is connected to the plurality of negative electrode current collector tabs 130 extending from the laminate 110c.

### (Module Resin Casing)

The module resin casing 400 is made from a thermosetting resin or a thermoplastic resin. The resin used in the module resin casing 400 may be the same type as that used in the resin casing 300 described above.

The module resin casing 400 closely adheres to and covers the entire solid-state battery module 100A. In other words, the module resin casing 400 closely adheres to and covers the four side surfaces of the laminate group 110A orthogonal to the laminating direction C, the four side surfaces orthogonal to the laminating direction C of the second elastic members 150a to 150d and the surface opposite the surface in contact with the laminate group 110A in the laminating direction C of each of the second elastic members 150a and 150d, the positive electrode current collector tabs 120, and the negative electrode current collector tabs 130. In addition, the module resin casing 400 closely adheres to and covers at least the end portions 201 of the lead terminals 200c to 200h connected to the positive electrode current collector tabs 120 or the negative electrode current collector tabs 130.

The method for forming the module resin casing 400 is not particularly limited, and any known method may be used. For example, the module resin casing 400 may be formed by placing the solid-state battery module 100A with the lead terminals 200A connected thereto in a die, filling the die with a thermosetting resin or a thermoplastic resin in liquid form at or below the melting point, and then curing the resin. At this time, the end portions 202 of the lead terminals 200A are arranged outside of the die, and the end portions 201 of the lead terminals 200A are positioned inside the die.

The solid-state battery unit 1A according to the present embodiment exhibits the following effects.

The solid-state battery unit 1A according to the present embodiment includes: a solid-state battery module 100A including a laminate group 110A constituted by a plurality of laminates 110 laminated in the laminating direction C, and second elastic members 150 arranged at least on both sides of the laminate group 110A in the laminating direction C; and a module resin casing 400 made of a thermosetting resin or a thermoplastic resin and which closely adheres to and covers the solid-state battery module 100A. This makes it possible to protect a solid-state battery module 100A wherein a plurality of laminates 110 are arranged in parallel in one module resin casing 400, which eliminates the need to provide a resin casing for each laminate 110, thus allowing for miniaturization of the solid-state battery unit 1A. In addition, since the module resin casing 400 closely adheres to and covers the entire solid-state battery module 100A including the laminate group 110A, the entire solid-state battery module 100A can be more reliably protected. Further, even if the entire solid-state battery module 100A is covered by the module resin casing 400 without any gaps, if a change in volume of the laminate group 110A occurs due to expansion of the negative electrode active material layers 22 caused by charging or discharging, the second elastic members 150 interposed between the laminate group 110A and the module resin casing 400 will be compressed according to the change in volume. It is thus possible to miniaturize and ensure a higher mechanical strength of the solid-state battery unit 1A while suppressing damage to the module resin casing 400 due to changes in volume of the laminate group 110A.

In addition, the second elastic members 150 of the solid-state battery unit 1A according to the present embodiment are arranged on both sides of each of the plurality of laminates 110 in the laminating direction C. Thus, since the second elastic members 150 are arranged on both sides in the laminating direction C of each laminate 110 included in the laminate group 110A, the second elastic members 150 can be more reliably compressed according to a change in volume of each laminate 110.

In addition, the second elastic members 150 of the solid-state battery unit 1A according to the present embodiment are insulative. This makes it possible to ensure insulation between each laminate 110 of the solid-state battery module 100A even if the laminates 110 are connected in series.

An embodiment of the present invention has been described above, but the present invention is not limited to the above embodiment, and various modifications are possible.

In the above embodiment, the laminate 110 of the solid-state battery 1 has three positive electrodes 10, four negative electrodes 20, and six solid-state catalysts 30, but so long as the solid-state catalysts 30 are interposed between the positive electrodes 10 and the negative electrodes 20, the number of positive electrodes 10, negative electrodes 20, and solid-state catalysts 30 of the laminate 110 is not particularly limited. For example, the number of positive electrodes 10 may be two or less, or four or more. In addition, the number of negative electrodes 20 may be three or less, or five or more. In addition, the number of solid-state catalysts 30 may be five or less, or seven or more.

In the above embodiment, the first elastic members 140 are arranged on both sides in the laminating direction C of the laminate 110 of the solid-state battery 1, but first elastic members 140 may be additionally arranged at the side surfaces of the negative electrode active material layers 22 of the laminate 110 orthogonal to the laminating direction C.

In the above embodiment, the solid-state battery module 100A of the solid-state battery unit 1A has three laminates 110, but so long as there are two or more laminates 110, the number is not particularly limited. For example, the number of laminates 110 in the solid-state battery module 100A, may be two, or four or more.

In the above embodiment, the second elastic members 150 of the solid-state battery unit 1A are arranged on both sides in the laminating direction C of all laminates 110 in the solid-state battery module 100A, but they may be arranged only on both sides of the laminate group 110A. In addition, second elastic members 150 may be additionally arranged at the side surfaces of the negative electrode active material layers 22 of the laminates 110 orthogonal to the laminating direction C. Moreover, in case the laminates 110 in the solid state battery module 100A are connected in series, an insulating member is interposed between each laminate 110.

### EXPLANATION OF REFERENCE NUMERALS

1 Solid-state battery

10, 10a, 10b, 10c Positive electrode
11 Positive electrode current collector
12 Positive electrode active material layer
20, 20a, 20b, 20c, 20d Negative electrode
21 Negative electrode current collector
22 Negative electrode active material layer
30, 30a, 30b, 30c, 30d, 30e, 30f Solid-state electrolyte
100 Solid-state battery cell
110 Laminated structure
140, 140a, 140b First elastic member
300 Resin casing

What is claimed is:

1. A solid-state battery comprising:
a solid-state battery cell including a laminate having at least one positive electrode having a positive electrode current collector and a positive electrode active material layer, at least one negative electrode having a negative electrode current collector and a negative electrode active material layer, and a solid-state electrolyte interposed between the positive electrode and the negative electrode, and a first elastic member arranged at least on both sides of the laminate in a laminating direction; and
a resin casing that is made of a thermosetting resin or a thermoplastic resin and closely adheres to and covers the solid-state battery cell.

2. The solid-state battery according to claim 1, the solid-state battery cell further comprising a positive electrode current collector tab extending in a direction away from the laminate from an end portion of the positive electrode current collector in a direction orthogonal to the laminating direction; and
a negative electrode current collector tab extending in a direction away from the laminate from an end portion of the negative electrode current collector in a direction orthogonal to the laminating direction,
wherein the resin casing closely adheres to and covers the positive electrode current collector tab and the negative electrode current collector tab.

3. The solid-state battery according to claim 1, wherein a surface of the first elastic member that is in contact, with the laminate has an area equal to or greater than that of a surface of the negative electrode active material layer orthogonal to the laminating direction.

4. The solid-state battery according to claim 1, wherein a total maximum compression amount in a thickness direction of the first elastic member arranged on both sides of the laminate in the laminating direction is greater than a maximum expansion amount of the laminate.

5. The solid-state battery according to claim 1, wherein a negative electrode active material constituting the negative electrode active material layer is hard carbon.

6. The solid-state battery according to claim 1, wherein a negative electrode active material constituting the negative electrode active material layer is graphite, and a capacity ratio (negative capacity/positive capacity) of the negative electrode and the positive electrode is 1.1 or more.

7. A solid-state battery unit comprising:
a solid-state battery module including a group of a plurality of laminates each having at least one positive electrode having a positive electrode current collector and a positive electrode active material layer, at least one negative electrode having a negative electrode current collector and a negative electrode active material layer, and a solid-state electrolyte interposed between the positive electrode and the negative electrode, the laminates being stacked in a laminating direction of each laminate, and a second elastic member arranged at least on both sides of the laminate group in the laminating direction; and
a module resin casing that is made of a thermosetting resin or a thermoplastic resin and closely adheres to and covers the solid-state battery module.

8. The solid-state battery unit according to claim 7, wherein the second elastic member is arranged on both sides in the laminating direction of each of the plurality of laminates.

9. The solid-state battery module according to claim 7, wherein the second elastic member is insulative.
